(19) United States
(12) Patent Application Publication
(10) Pub. No.: US 2015/0029871 A1
(43) Pub. Date: Jan. 29, 2015

(54) SERVICE LEVEL AGREEMENT VALIDATION VIA SERVICE TRAFFIC SAMPLE-AND-REPLAY

(71) Applicant: CISCO TECHNOLOGY, INC., San Jose, CA (US)

(72) Inventors: Dan Frost, Middlesex (GB); Stewart Frederick Bryant, Surrey (GB)

(73) Assignee: CISCO TECHNOLOGY, INC., San Jose, CA (US)

(21) Appl. No.: 13/949,492

(22) Filed: Jul. 24, 2013

(51) Int. Cl. H04L 12/24; H04L 12/26

(52) U.S. Cl. CPC H04L 41/5038; H04L 43/022; H04L 43/0829
USPC 370/252

(57) ABSTRACT

In one embodiment, a device samples actual service traffic at a device in a computer network, and generates real-time statistics on distribution of various packet header parameters of the sampled traffic that influence forwarding in the computer network. As such, the device may generate and transmit synthetic measurement traffic according to the distribution. For instance, in one embodiment, the synthetic traffic may be a replay of actual service traffic with an indication that the replayed traffic is synthetic, while in another embodiment, newly generated synthetic measurement traffic may have packet header parameters substantially matching the sampled traffic.

### TECHNICAL FIELD

The present disclosure relates generally to computer networks, and, more particularly, to service level agreement (SLA) validation in computer networks.

### BACKGROUND

The validation of Service Level Agreements (SLAs) for a client service carried over an Internet Protocol (IP)/Multi-Protocol Label Switching (MPLS) network through accurate measurement of quality metrics such as packet loss and delay associated with a customer traffic flow is an increasingly dominant concern for service providers and a rapidly-emerging requirement. Currently, the mechanisms available for packet loss measurement in IP/MPLS networks are limited and often insufficient to meet stringent SLA validation requirements.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network;

FIG. 2 illustrates an example network device/node;

FIG. 3 illustrates an example of actual service traffic;

FIG. 4 illustrates an example of a distribution of sampled traffic;

FIG. 5 illustrates an example of synthetic measurement traffic;

FIG. 6 illustrates an example of actual versus synthetic packet formats;

FIG. 7 illustrates an example of replayed measurement traffic; and

FIG. 8 illustrates an example simplified procedure for SLA validation via service traffic sample-and-replay in a computer network.

### DESCRIPTION OF EXAMPLE EMBODIMENTS

### Overview

According to one or more embodiments of the disclosure, a device samples actual service traffic at a device in a computer network, and generates real-time statistics on distribution of various packet header parameters of the sampled traffic that influence forwarding in the computer network. As such, the device may generate and transmit synthetic measurement traffic according to the distribution. For instance, in one embodiment, the synthetic traffic may be a replay of actual service traffic with an indication that the replayed traffic is synthetic, while in another embodiment, newly generated synthetic measurement traffic may have packet header parameters substantially matching the sampled traffic.

### Description

A computer network is a geographically distributed collection of nodes interconnected by communication links and segments for transporting data between end nodes, such as personal computers and workstations. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP), the User Datagram Protocol (UDP), or Real-time Transport Protocol (RTP). In this context, a protocol consists of a set of rules defining how the nodes interact with each other. Computer networks may be further interconnected by an intermediate network node, such as a router, to extend the effective “size” of each network.

Since management of interconnected computer networks can prove burdensome, smaller groups of computer networks may be maintained as routing domains or autonomous systems. The networks within an autonomous system (AS) are typically coupled together by conventional “intradomain” routers configured to execute intradomain routing protocols, and are generally subject to a common authority. To improve routing scalability, a service provider (e.g., an ISP) may divide an AS into multiple “areas” or “levels.” It may be desirable, however, to increase the number of nodes capable of exchanging data; in this case, interdomain routers executing interdomain routing protocols are used to interconnect nodes of the various ASes. Moreover, it may be desirable to interconnect various ASes that operate under different is administrative domains. As used herein, an AS, area, or level is generally referred to as a “domain.”

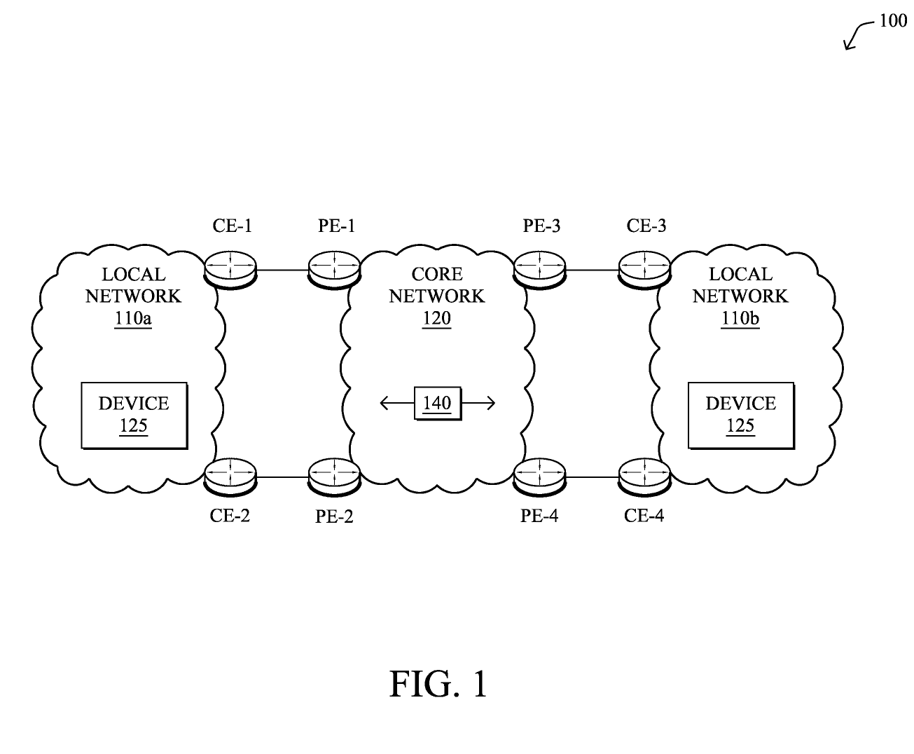

FIG. 1 is a schematic block diagram of an example computer network 100 illustratively comprising nodes/devices, such as a plurality of routers/devices interconnected by links or networks, as shown. For example, customer edge (CE) devices (e.g., CE1, CE2, CE3, and CE4) and provider edge (PE) devices (e.g., PE1, PE2, PE3, and PE4) may allow for communication between devices 125 within two or more local networks 110a,b via a core network 120 (e.g., a service provider network). Those skilled in the art will understand that any number of nodes, devices, links, etc. may be used in the computer network, and that the view shown herein is for simplicity. Those skilled in the art will also understand that while the embodiments described herein is described generally, it may apply to any network configuration within an Autonomous System (AS) or area, or throughout multiple ASes or areas, across a WAN (e.g., the Internet), etc.

Data packets 140 may be exchanged among the network devices of the computer network 100 over links using predefined network communication protocols such as certain known wired protocols, wireless protocols, or other protocols where appropriate. In this context, a protocol consists of a set of rules defining how the devices interact with each other.

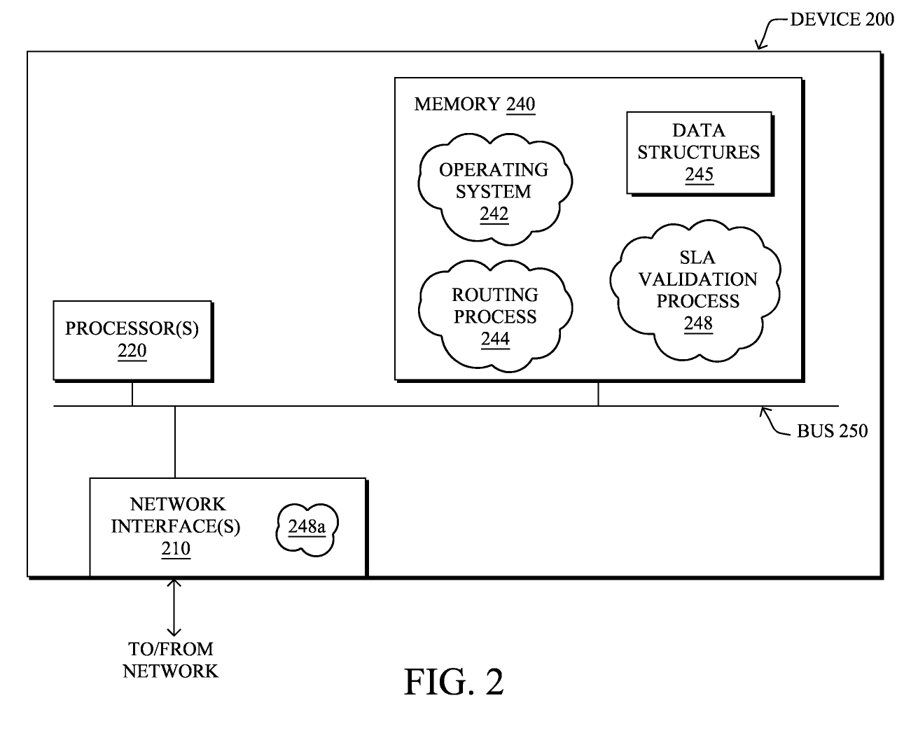

FIG. 2 is a schematic block diagram of an example device 200 that may be used with one or more embodiments described herein, e.g., such as any of the PE devices or other devices as shown in FIG. 1 above. The device may comprise one or more network interfaces 210, one or more processors 220, and a memory 240 interconnected by a system bus 250. The network interface(s) 210 contain the mechanical, electrical, and signaling circuitry for communicating data over links coupled to the network 100. The network interfaces may be configured to transmit and/or receive data using a variety of different communication protocols. Notably, a physical network interface 210 may also be used to implement one or more virtual network interfaces, such as for Virtual Private Network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor(s), functionally organizes the device by, inter alia, invoking operations in support of software processes and/or services executing on the device. These software processes and/or services may comprise routing process/services 244 and an illustrative service level agreement (SLA) process 248, as described herein, which may alternatively be located within individual network interfaces (e.g., process 248a).

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Routing process/services 244 contain computer executable instructions executed by processor 220 to perform functions provided by one or more routing protocols, such as the Interior Gateway Protocol (IGP) (e.g., Open Shortest Path First, “OSPF,” and Intermediate-System-to-Intermediate-System, “IS-IS”), the Border Gateway Protocol (BGP), etc., as will be understood by those skilled in the art. These functions may be configured to manage a forwarding information database (not shown) containing, e.g., data used to make forwarding decisions. In particular, changes in the network topology may be communicated among routers 200 using routing protocols, such as the conventional OSPF and IS-IS link-state protocols (e.g., to “converge” to an identical view of the network topology). Notably, routing services 244 may also perform functions related to virtual routing protocols, such as maintaining VRF instances (not shown), or tunneling protocols, such as for Multi-Protocol Label Switching (MPLS), generalized MPLS (GMPLS), etc., each as will be understood by those skilled in the art.

As noted above, the validation of Service Level Agreements (SLAs) for a client service carried over a network (e.g., an IP network, an MPLS network, an IP/MPLS network, etc.) through accurate measurement of quality metrics such as packet loss and delay associated with a customer traffic flow is an increasingly dominant concern for service providers and a rapidly-emerging requirement. Currently, the mechanisms available for packet loss measurement in such networks are limited and often insufficient to meet stringent SLA validation requirements. In particular, the general class of SLA validation via synthetic probing is well known and widely deployed today. The current tools typically work by configuring a designated probe device to generate various kinds of requests to a “responder” router elsewhere in the network, such as Internet Control Message Protocol (ICMP) “pings” or Hypertext Transfer Protocol (HTTP) “get” requests (and others), and then measure and compute various statistics based on the results of these requests, such as the delay and delay variation they experienced in transit.

The techniques herein, similar to existing tools, involve generating synthetic traffic which is treated as a proxy for the real service traffic, and which is measured in order to draw inferences about the treatment by the network of the real service traffic. Apart from this point in common, however, the techniques herein are quite different from the mechanisms deployed today, as will be detailed below.

In particular, the techniques herein provide for service traffic measurement based on synthetic traffic flows that provides a high degree of fidelity compared to existing methods. For instance, according to the techniques herein, a subset of live customer traffic may be continuously sampled and used to automatically generate a near-identical stream of synthetic measurement traffic which is used for SLA validation. This synthetic traffic stream serves as a high-fidelity proxy for the live traffic due to the manner of its construction.

Specifically, according to one or more embodiments of the disclosure as described in detail below, a device (e.g., PE device) samples actual service traffic at a device in a computer network, and generates real-time statistics on distribution of various packet header parameters of the sampled traffic that influence forwarding in the computer network. As such, the device may generate and transmit synthetic measurement traffic according to the distribution. For instance, in one embodiment, the synthetic traffic may be a replay of actual service traffic with an indication that the replayed traffic is synthetic, while in another embodiment, newly generated synthetic measurement traffic may have packet header parameters substantially matching the sampled traffic.

Illustratively, the techniques described herein may be performed by hardware, software, and/or firmware, such as in accordance with the SLA validation process 248/248a, which may contain computer executable instructions executed by the processor 220 (or independent processor of interfaces 210) to perform functions relating to the techniques described herein. For example, the techniques herein may be treated as extensions to conventional quality measurement protocols, and as such, may be processed by similar components understood in the art that execute those protocols, accordingly.

As noted, the concept of the techniques herein involves sampling all, or some defined subset, of the actual service traffic, generating real-time statistics on the distribution of the various packet header parameters that influence forwarding in the network, and then automatically generating synthetic measurement traffic according to this distribution. Alternatively, the actual sampled traffic can be directly replayed as synthetic measurement traffic, rather than just used as a statistical basis for synthetic traffic generation.

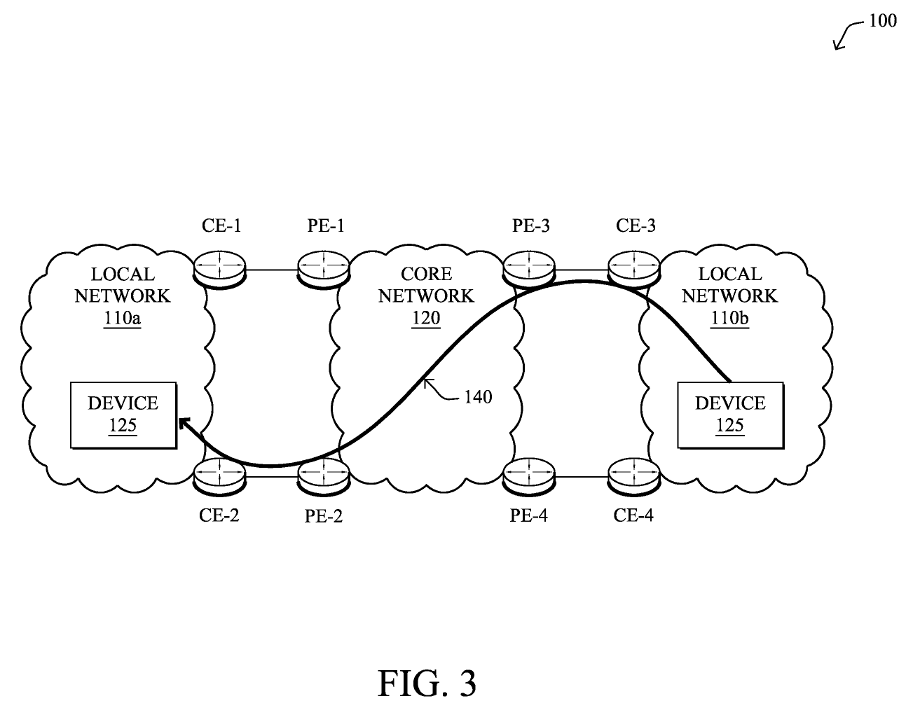

Operationally, assume as shown in FIG. 3 that a service provider core network 120 in which a specific ingress Provider Edge (PE) router (e.g., PE3) wishes to measure the packet loss incurred by the stream of packets “S” (140) originating from one of its attached Customer Edge (CE) devices (e.g., CE3) and destined for a remote CE attached to a specific egress PE (e.g., CE2 and PE2, respectively). For simplicity assume this is an MPLS network and the service traffic S is MPLS VPN traffic. The techniques herein are interested in measuring the treatment experienced by S-packets in traversing the network from ingress to egress; for example, the packet loss rate or average/peak packet delay.

First, the sending and receiving devices (e.g., ingress and egress PEs) may agree on a mechanism to distinguish synthetic traffic from real service traffic. One way to achieve this is a time-to-live (TTL)-based operations, administration, and management (OAM) indication, such as where the high-order bit of the TTL in the VPN label may be used to indicate synthetic traffic. Other tags, flags, types, fields, etc., may be used, and the TTL in a VPN label is merely one example.

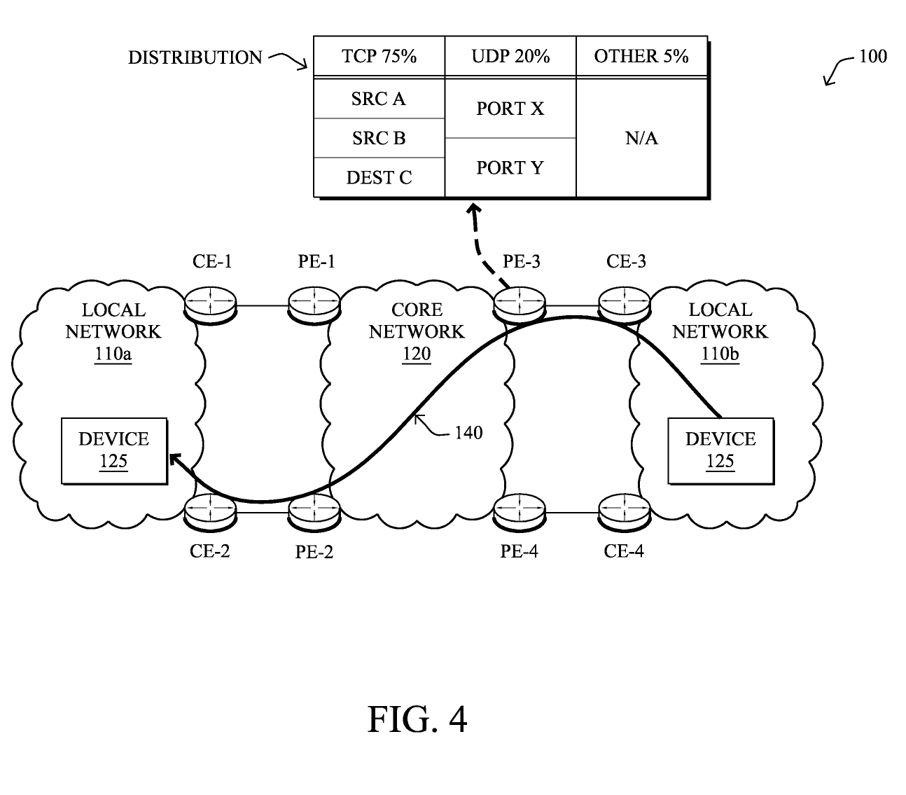

The ingress PE (or any other device) may set a “sampling filter” on the traffic it receives from its attached CE. In one embodiment, the filter could be null, i.e., an “accept everything” filter. As shown in FIG. 4, the ingress PE begins to compute a statistical distribution of traffic types from the traffic it receives from the CE that passes the sampling filter. “Traffic type” in this case refers to the values of certain header fields in the traffic, like source/destination IP address, transport protocol type, and source/destination port numbers, etc. The result of this computation will be a running breakdown of the proportion of traffic falling into different buckets; for example, “75% TCP traffic, 20% UDP traffic, 5% other”, with further breakdown of TCP and UDP traffic into more specific flow buckets, and so on. For example, different sources (SRC), destinations (DEST), ports, combinations (e.g., Source AND Destination, Source AND Destination AND port, etc.) may also be used to differentiate the traffic distribution categories.

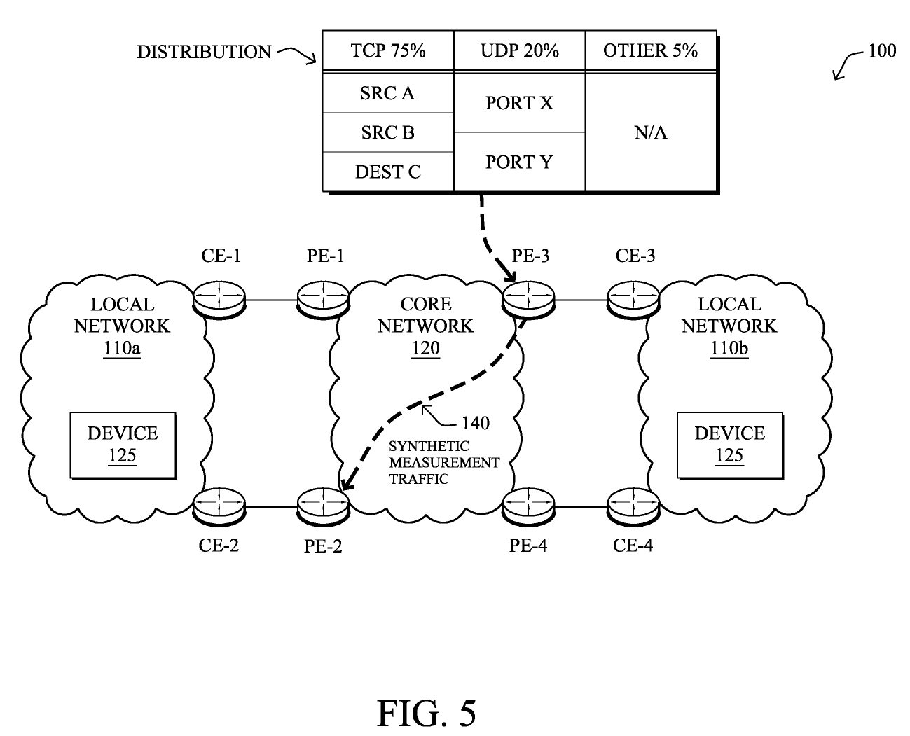

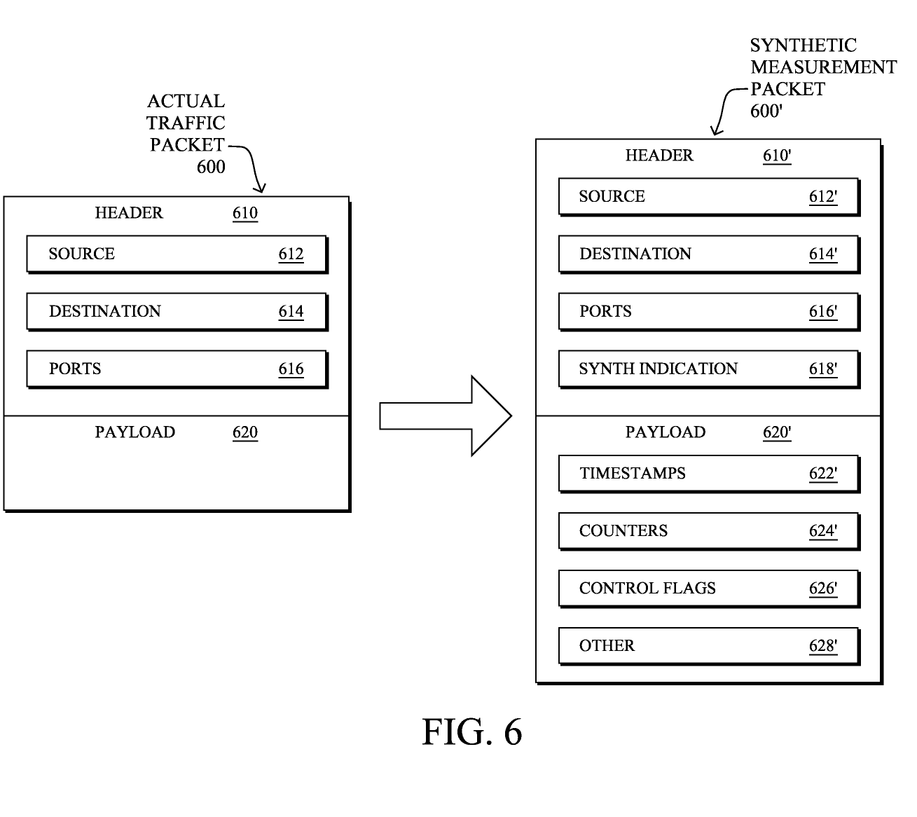

The ingress PE (or other measurement device made aware of the sampled distribution) uses this “bucket breakdown” as a template for the automatic generation of synthetic traffic which will be subjected to SLA measurement. For example, as shown in FIG. 5, the ingress PE generates a stream S′ of synthetic traffic, which based on the distribution of the sampled stream S, 75% of the synthetic traffic is TCP, 20% of which is UDP, and so on, with further differentiation matching the profile of the sampled S-packets. As shown in FIG. 6, the headers 610′ of the synthetic packets 600′ look exactly like their real equivalents (headers 610 of actual traffic packets 600) in all respects that affect forwarding treatment in the network (e.g., source 612/612′, destination 614/614′, ports 616/616′, etc.); they are distinguished only by the indication 618 agreed upon as mentioned above. The payloads 620′ of the synthetic packets can contain whatever is required for measurement purposes, such as timestamps 622′, packet counters 624′, control flags 626′, or other fields 628′, and need not match the payload 620 of the actual traffic 600. Note that the actual measurement can be accomplished, for example, with protocols such as RFC 6374 packet loss and delay measurement.

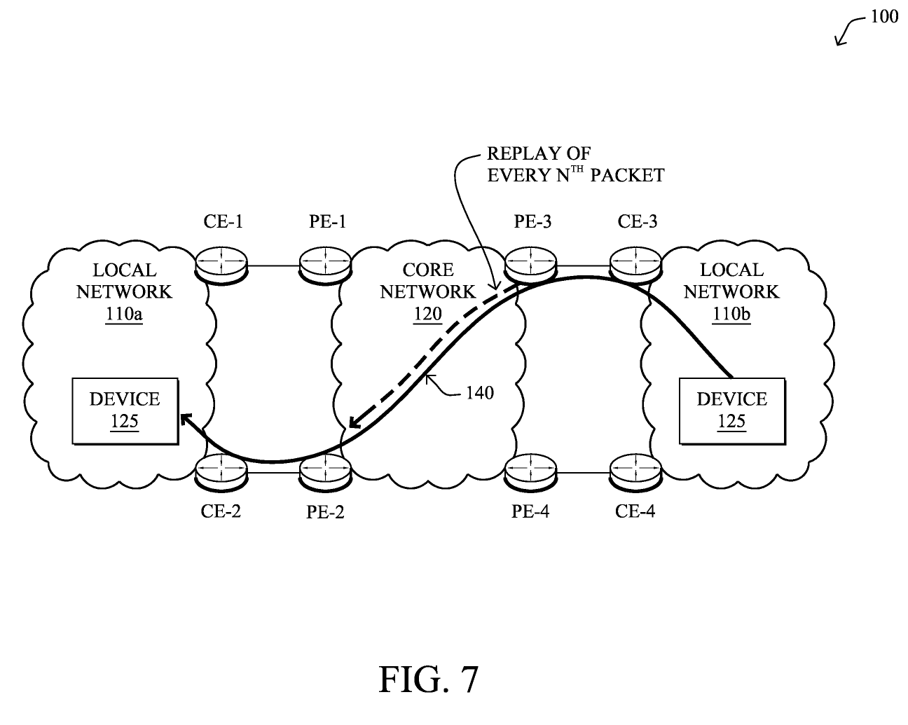

As an alternative embodiment, rather than building a statistical distribution of S-packet types and generating synthetic equivalents, the ingress PE may simply capture and replay some sampled subset of the real packet stream S. For example, as shown in FIG. 7, the ingress PE may replay every n^{th} (e.g., every 1000^{th}) S-packet. As mentioned above, the replay packets have identical headers to their real correspondents except for the distinguishing mechanism agreed upon above, and their payloads can contain whatever is required for measurement purposes. Note that the replay of packets may be substantially immediate, delayed by some random or selected amount, or else the packets may be time-stamped and replayed according to those timestamps (e.g., the following day) to result in a more complete emulation of the traffic behavior.

The result of this procedure is a stream S′ of synthetic packets that reflects the precise characteristics of the real service traffic stream S. This stream S′ is automatically derived from and generated based on S, and serves as a proxy for S for purposes of SLA measurement. Moreover, S′ is an especially good proxy as it consists of packets with identical headers and in equivalent proportions to those occurring in S.

Notably, traffic anonymization is an important consideration, and this includes generating synthetic traffic based on the IP addresses of real traffic. The techniques herein work with unobfuscated addresses (and payload headers) in order to correctly replicate the traffic pattern under investigation. For data pattern sensitivity investigations, a sample of real user data is needed unless the nature of the sensitivity is known and can be mimicked. However in more common cases the data could be some form of padding.

Note further that there are two overarching potential modes of operation, a mode in which the traffic is captured and stored on the PE device (or other device), and a mode in which the traffic is captured on the PE device, but stored on a server for replay. In each case there are two modes, one in which only the essential characteristics of the data is stored (headers used for delivery and ECMP+payload length) and the other in which the actual payload is stored. Obviously the less ephemeral the storage the greater the security risk and the greater the need for data security techniques such as encryption of the stored content. There are a number of mitigating factors that may be taken into consideration:
1) The non-ephemeral storage of headers is already undertaken for network instrumentation purposes when current network flow measurement protocols are deployed. The non-ephemeral storage of complete packets is undertaken for network instrumentation purposes when a network data analyzer is deployed. In cases above it can be assumed that the operator has an appropriate data security policy in place that covers these cases and that these policies would also cover the this application.
2) The ephemeral capture of headers and complete packets for playout over the network is an intrinsic part of the normal operation of a router. In the above case the visibility of the captured data is little different from the visibility of the date available through the inspection for the internal memory of a router and it can be assumed that the operator has in place confidentially and security policies that cover this.
3) The re-playout of the user data over the network has the same security issues as occur in normal operation of the network.

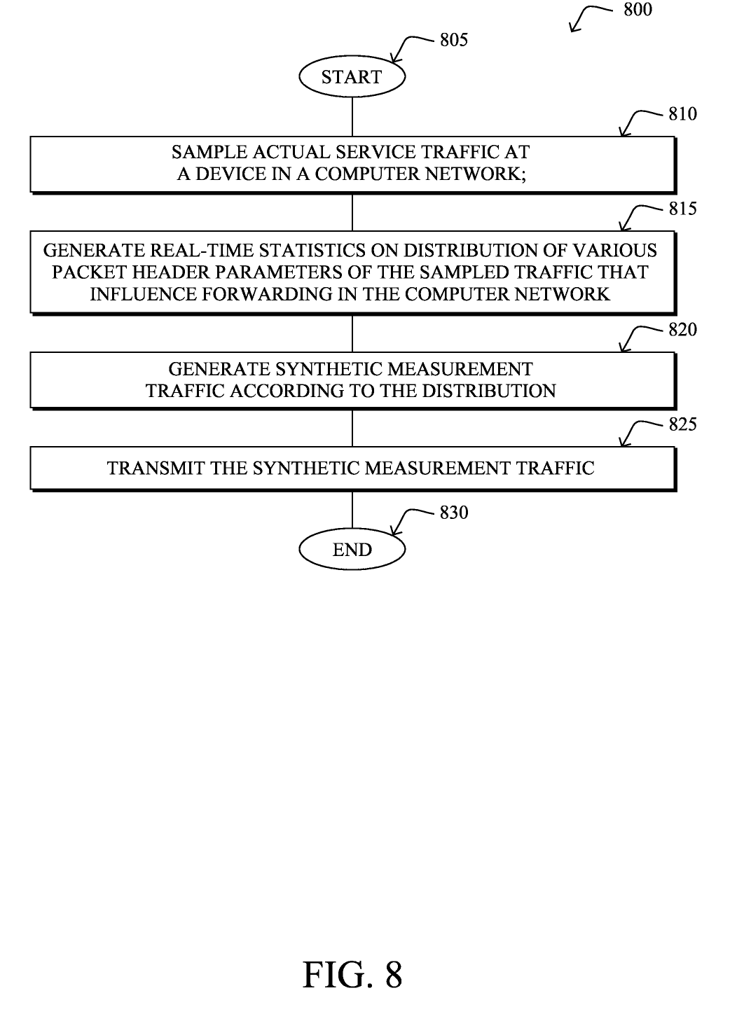

FIG. 8 illustrates an example simplified procedure 800 for SLA validation via service traffic sample-and-replay in a computer network in accordance with one or more embodiments described herein. The procedure 800 may start at step 805, and continues to step 810, where, as described in greater detail above, a device (e.g., a service provider IP/MPLS network PE device) samples actual service traffic in a computer network (e.g., all service traffic or a subset of service traffic), and in step 815 generates real-time statistics on distribution of various packet header parameters of the sampled traffic that influence forwarding in the computer network. For instance, as mentioned above, such packet header parameters may be one or more of a source address, destination address, transport protocol type, source port, destination port, traffic type, traffic priority, etc. In step 820, the device may then generate synthetic measurement traffic according to the distribution, and transmits the synthetic measurement traffic in step 825. Notably, as detailed above, generating and transmitting the synthetic traffic may entail replaying actual service traffic with an indication that the replayed traffic is synthetic (e.g., transmitting the synthetic measurement traffic as a replay of every nth packet received), or else substantially matching the packet header parameters of newly generated synthetic measurement traffic to the sampled traffic.

The procedure 800 illustratively ends in step 830, though notably with the ability to continuously sample traffic, update the distribution, and generate and transmit measurement traffic, accordingly. It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide for SLA validation via service traffic sample-and-replay in a computer network. In particular, the techniques herein provide advantages over existing SLA measurement solutions based on synthetic probing. First, the synthetic stream is derived automatically from the real service traffic stream. There is no need for the user to explicitly design and configure a collection of different kinds of probes as in existing solutions. Second, the synthetic stream constructed by this solution is a much better approximation to the real service traffic than is the case for separately-configured probes. Specifically, the synthetic packets generated is via this solution are constructed in such a way that their headers are completely identical to the headers of real service packets in every respect that affects treatment by the network: they can have the same source/destination IP addresses, the same port numbers, the same protocol types, and the same quality-of-service markings as the real packets. In particular this means that the synthetic packets are guaranteed to receive the same Equal Cost Multipath (ECMP) forwarding treatment as the real service packets. This makes them a much more reliable indicator of the real traffic experience than is the case with existing solutions.

Note also that connection-oriented protocols may not generally be amenable to simple replay in terms of generating realistic behavior and thus statistically valid measurements. The techniques herein, however, emulate unidirectional traffic flows with the same ECMP behavior as customer data. As such it is sufficient to capture and replay the ingress traffic. The packet sets that the user application sets generate will intrinsically be generated by the application during the period of data capture, and thus there is no need to add any complexity in the OAM techniques herein to deal with any form of application emulation.

While there have been shown and described illustrative embodiments that provide for SLA validation via service traffic sample-and-replay in a computer network, it is to be understood that various other adaptations and modifications may be made within the spirit and scope of the embodiments herein. For example, the embodiments have been shown and described herein with relation to certain types of networks, such as service provider network and PE devices. However, the embodiments in their broader sense are not as limited, and may, in fact, be used with other types of networks (e.g., private networks) and/or quality measurement devices within those networks. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
sampling actual service traffic at a device in a computer network;
generating real-time statistics on distribution of various packet header parameters of the sampled traffic that influence forwarding in the computer network; and
generating and transmitting synthetic measurement traffic according to the distribution.

2. The method as in claim 1, wherein generating and transmitting synthetic measurement traffic comprises:
replaying actual service traffic with an indication that the replayed traffic is synthetic.

3. The method as in claim 1, wherein generating and transmitting synthetic measurement traffic according to the distribution comprises:
substantially matching the packet header parameters of newly generated synthetic measurement traffic to the sampled traffic.

4. The method as in claim 1, wherein generating and transmitting synthetic measurement traffic according to the distribution comprises:
transmitting the synthetic measurement traffic as a replay of every n^{th} packet received.

5. The method as in claim 1, wherein sampling comprises:
sampling one of either all service traffic or a subset of service traffic.

6. The method as in claim 1, wherein the device is a service provider network provider edge device.

7. The method as in claim 1, wherein the device is an ingress device to a Multi-Protocol Label Switching (MPLS) network.

8. The method as in claim 1, wherein the packet header parameters are selected from a group consisting of: source address; destination address; transport protocol type; source port; destination port; traffic type; and traffic priority.

9. An apparatus, comprising:
one or more network interfaces to communicate with a computer network;
a processor coupled to the network interfaces and adapted to execute one or more processes; and
a memory configured to store a process executable by the processor, the process when executed operable to:
sample actual service traffic in the computer network;
generate real-time statistics on distribution of various packet header parameters of the sampled traffic that influence forwarding in the computer network; and
generate and transmit synthetic measurement traffic according to the distribution.

10. The apparatus as in claim 9, wherein the process when executed to generate and transmit synthetic measurement traffic is further operable to:
replay actual service traffic with an indication that the replayed traffic is synthetic.

11. The apparatus as in claim 9, wherein the process when executed to generate and transmit synthetic measurement traffic according to the distribution is further operable to:
substantially match the packet header parameters of newly generated synthetic measurement traffic to the sampled traffic.

12. The apparatus as in claim 9, wherein the process when executed to generate and transmit synthetic measurement traffic according to the distribution is further operable to:
transmit the synthetic measurement traffic as a replay of every n^{th} packet received.

13. The apparatus as in claim 9, wherein the process when executed to sample is further operable to:
sample one of either all service traffic or a subset of service traffic.

14. The apparatus as in claim 9, wherein the apparatus is a service provider network provider edge device.

15. The apparatus as in claim 9, wherein the apparatus is an ingress device to a Multi-Protocol Label Switching (MPLS) network.

16. The apparatus as in claim 9, wherein the packet header parameters are selected from a group consisting of: source address; destination address; transport protocol type; source port; destination port; traffic type; and traffic priority.

17. A tangible, non-transitory, computer-readable media having software encoded thereon, the software when executed by a processor operable to:
sampling actual service traffic at a device in a computer network;
generating real-time statistics on distribution of various packet header parameters of the sampled traffic that influence forwarding in the computer network; and
generating and transmitting synthetic measurement traffic according to the distribution.

18. The computer-readable media as in claim 17, wherein the software when executed to generate and transmit synthetic measurement traffic is further operable to:
replay actual service traffic with an indication that the replayed traffic is synthetic.

19. The computer-readable media as in claim 17, wherein the software when executed to generate and transmit synthetic measurement traffic according to the distribution is further operable to:
substantially match the packet header parameters of newly generated synthetic measurement traffic to the sampled traffic.

20. The computer-readable media as in claim 17, wherein the software when executed to generate and transmit synthetic measurement traffic according to the distribution is further operable to:
transmit the synthetic measurement traffic as a replay of every n^{th} packet received.
